(19) United States
(12) Patent Application Publication
(10) Pub. No.: US 2026/0166948 A1
(43) Pub. Date: Jun. 18, 2026

(54) SYSTEM AND METHOD FOR RAPID RECOVERY OF FLUID REFRIGERANT

(71) Applicant: Robert Bosch GmbH, Stuttgart (DE)

(72) Inventors: Jacob Hanson, Owatonna, MN (US); Valerio Doino, Rochester, MN (US)

(21) Appl. No.: 18/980,089

(22) Filed: Dec. 13, 2024

(51) Int. Cl. B60H 1/00

(52) U.S. Cl. CPC B60H 1/00585

(57) ABSTRACT

A system and method for rapid recovery of refrigerant from the refrigeration circuit of a vehicle. The method utilizes the compressor of the refrigeration circuits working in tandem with the compressor of a service cart. The recovery finishes using only the compressor of the service cart.

### TECHNICAL FIELD

This disclosure relates to routine operations of air conditioning service carts. In particular, this disclosure is directed to service carts utilized during service and maintenance of air conditioning systems of vehicles.

### BACKGROUND

Modern vehicles comprise air condition systems to provide rider comfort during operation. Service of vehicular refrigeration circuits (for the air conditioning systems of vehicles) rely upon removal of refrigerant from the system, in order to prevent mess in service environments, comply with regulation, and preserve refrigerant for re-use. Removal of refrigerant from refrigeration services relies upon a “recovery” process, typically performed by a technician utilizing a service cart having a storage tank into which the refrigerant is recovered.

Conventional recoveries of refrigerant take a significant amount of time, which provides a bottleneck to professional service environments seeking to optimize throughput of customer vehicles requiring service. What is desired is a way to minimize the amount of time required for a proper and complete refrigerant recovery.

### SUMMARY

One aspect of this disclosure is directed to a method of refrigerant recovery from a vehicle using a service cart having a high-side port and a low-side port each in fluid communication with an active refrigeration circuit of the vehicle. The method comprises engaging a compressor of the service cart, engaging the high-side port such that it is open and the low-side port such that it is closed, and opening the low-side port in response to a high-side pressure data value falling below a first threshold value. The high-side pressure data is generated by a high-side transducer in fluid communication with the high-side port. The high-side port and the low-side port are controlled by a controller in data communication with the high-side transducer. The method utilizes an engaged compressor of the vehicle's refrigeration system in combination with the compress of the service cart. In some embodiments, the compressor of the vehicle's refrigeration system may be initiated prior to the method. The method may further comprise disengaging the compressor in response to the high-side pressure data and a low-side pressure data falling below a second threshold value for a window of time. The low-side pressure data is generated by a low-side transducer in fluid communication with the low-side port.

Another aspect of this disclosure is directed to a method of refrigerant recovery from a vehicle using a service cart having a high-side port and a low-side port each in fluid communication with an active refrigeration circuit of the vehicle. The method comprises engaging the high-side port such that it is open and the low-side port such that it is closed, engaging a compressor of the service cart, and opening the low-side port in response to a high-side pressure data value falling below a first threshold value. The high-side pressure data is generated by a high-side transducer in fluid communication with the high-side port. The high-side port and the low-side port are controlled by a controller in data communication with the high-side transducer. The method utilizes an engaged compressor of the vehicle's refrigeration system in combination with the compress of the service cart. In some embodiments, the compressor of the vehicle's refrigeration system may be initiated prior to the method. The method may further comprise disengaging the compressor in response to the high-side pressure data and a low-side pressure data falling below a second threshold value for a window of time. The low-side pressure data is generated by a low-side transducer in fluid communication with the low-side port.

A further aspect of this disclosure is directed to a non-transitory processor-readable medium having instructions stored thereon that, when read by a processor in data communication with a service cart having a high-side port and a low-side port in fluid communication with a refrigerant circuit of a vehicle with an engaged refrigerant circuit. The instructions cause the processor to perform the steps of engaging a compressor of the service cart, opening the high-side port, generating high-side pressure data indicating a fluid pressure exhibited at the first high-side port, and opening the first low-side port in response to the high-side pressure data value falling below a first threshold value. The high-side pressure data is generated using a high-side transducer of the service cart, and the high-side transducer is in fluid communication with the high-side port. The instructions utilize an engaged compressor of the vehicle's refrigeration system in combination with the compress of the service cart. In some embodiments, the compressor of the vehicle's refrigeration system may be initiated prior to the executions of the instructions. The instructions may further comprise disengaging the compressor in response to the high-side pressure data and a low-side pressure data falling below a second threshold value for a window of time. The low-side pressure data is generated by a low-side transducer in fluid communication with the low-side port.

The above aspects of this disclosure and other aspects will be explained in greater detail below with reference to the attached drawings.

### BRIEF DESCRIPTION OF THE DRAWINGS

FIG. 1 is an illustration of a vehicle and service cart during a service action for an air conditioning system of the vehicle.

FIG. 2 is an illustration of an air conditioning service cart.

FIG. 3 is a circuit diagram depicting a service cart circuit in fluid communication with a refrigeration circuit of a vehicle.

FIG. 4 is a flowchart illustrating a method of refrigerant recovery.

### DETAILED DESCRIPTION

The illustrated embodiments are disclosed with reference to the drawings. However, it is to be understood that the disclosed embodiments are intended to be merely examples that may be embodied in various and alternative forms. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts.

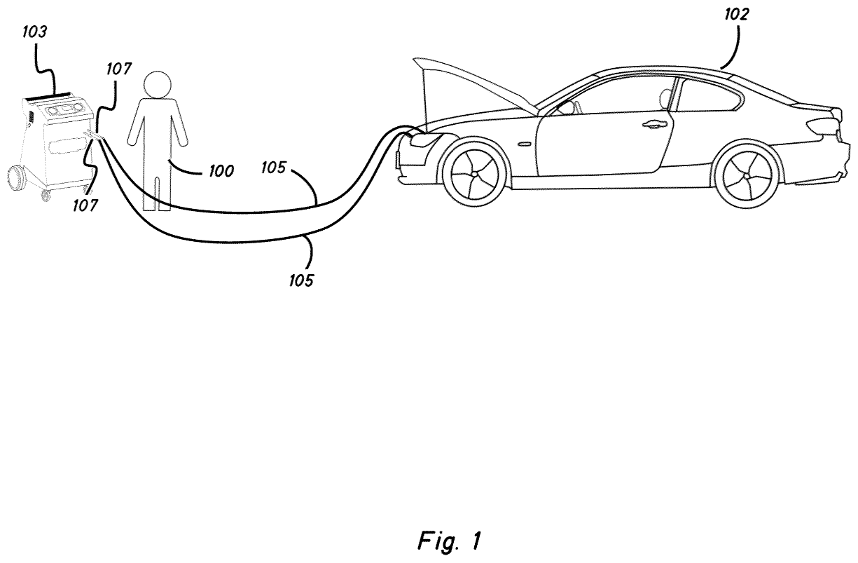

FIG. 1 depicts a typical use case of a user 100 performing a fluid exchange operation for a vehicle 102 using a service cart 103. In the depicted embodiment, the fluid exchange operation of service cart 103 is directed to the air conditioning system of vehicle 102, but other embodiments may be directed to other fluid exchange services without deviating from the teachings disclosed herein. In the depicted embodiment, refrigerant is moved between the vehicle 102 and service cart 103 via a number of hoses 105 that are coupled at one end to vehicle 102 and at the other end to service cart 103. Each of the hoses 105 are coupled to service cart 103 via a hose connector assembly 107 in an assembled state.

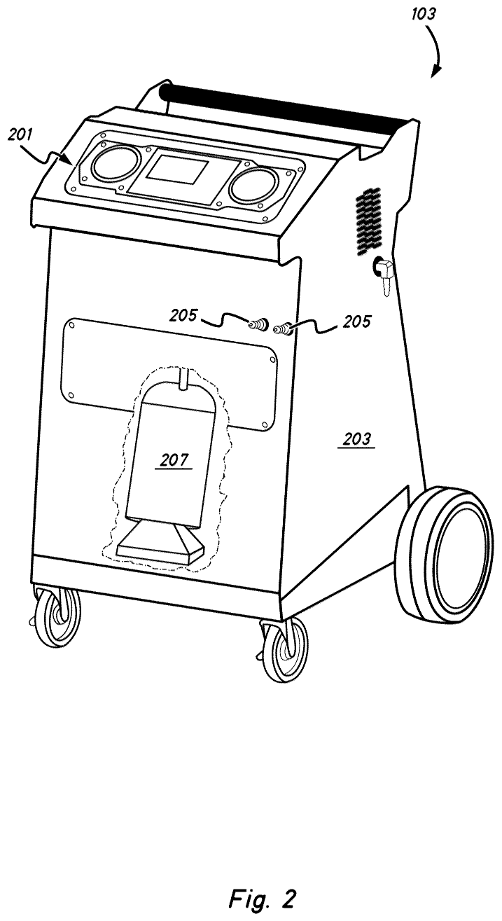

FIG. 2 depicts service cart 103 and components thereof. Service cart 103 comprises a console 201 providing a user with displays and controls for the functions of service cart 103. The chassis 203 of service cart 103 provides support for a number of ports 205 which provide fluid communication with a storage tank 207 at least partially disposed within chassis 203. In the depicted embodiment, ports 205 comprises a high-side port and a low-side port conventional to exchange refrigerant between a vehicle (such as vehicle 102; see FIG. 1) and service cart 103, but other embodiments may comprise other configurations without deviating from the teachings disclosed herein. During service, service cart 103 is operable to transfer refrigerant to and from the vehicle and storage tank 207 via ports 205. This transfer is accomplished utilizing pressure differentials within conduits exhibiting fluid communication between refrigerant circuits of the vehicle under service and also service cart 103.

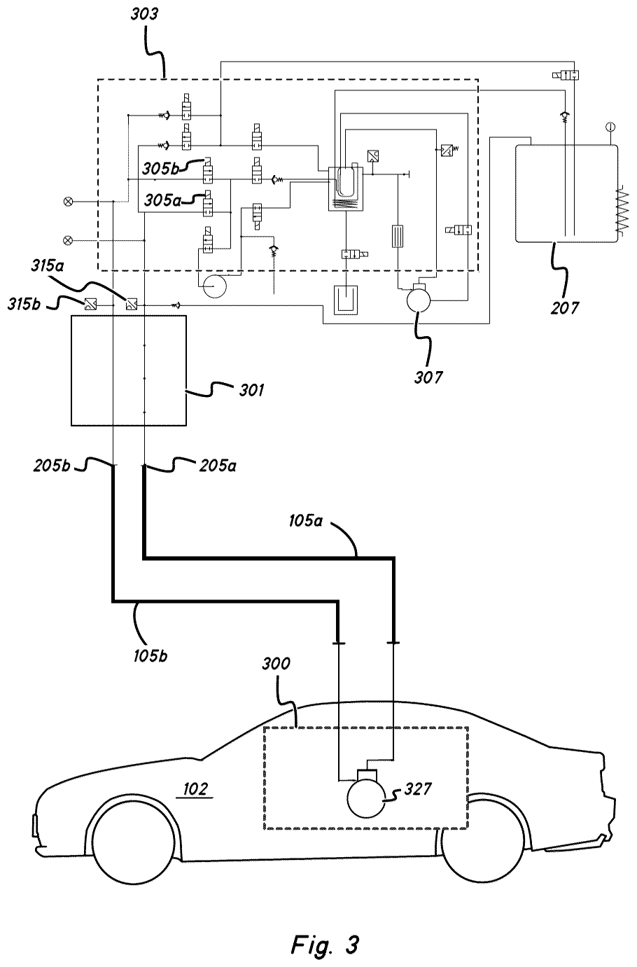

FIG. 3 is a simplified fluid circuit diagram illustrating a refrigeration circuit 300 of vehicle 102 in fluid communication with components of a service cart. It is first noted that in this diagram, intersections of fluid conduits are understood to only be in fluid communication when the intersection is marked with a connection point (i.e., a circular dot defining the fluid intersection). Otherwise, intersecting circuit lines are understood not to be in fluid communication with each other.

Some previously observed elements of the system are observable on this circuit diagram, including hoses 105, ports 205, and storage tank 207. In this depiction, hoses 105 are organized as high-side hose 105a and low-side hose 105b, each corresponding to the expected pressure as observed in the refrigeration circuit 300. Because the circuit is designed around these expected pressures, additional features of the circuit will additionally be differentiated by their associated with a high-side or low-side of the refrigeration circuit 300. In particular, high-side port 205a is connected to high-side hose 105a and low-side port 205b is connected to low-side hose 105b. The service cart side circuit comprises an injection manifold 301 and a main manifold 303. In this depiction, elements of each of the injection manifold 301 and main manifold 303 may be omitted if they do not relate to the operation of the invention described herein, and additional features may be present without deviating from the teachings disclosed herein.

In the depicted embodiment, monitoring of the high-side and low-side conduits is desired, and is accomplished using a set of transducers 315 in fluid communication with each port. In the depicted embodiment, high-side transducer 315a is in fluid communication with high-side port 205a and high-side inlet solenoid 305a. In the depicted embodiment, high-side transducer 315b is in fluid communication with high-side port 205b and high-side inlet solenoid 305b. Each of the transducers 315 generate pressure data indicating conditions within their respective fluid conduits, and the pressure data is provided to the controller via a data communication connection (not shown). The controller may utilize the pressure data of each fluid conduit to adjust the operational conditions of the components of injection manifold 301 and main manifold 303. Notably, the controller may not have operational control of any element of vehicle 102 without deviating from the teachings disclosed herein, but some embodiments may comprise control of one or more functions of vehicle 102 without deviating from the teachings disclosed herein.

A controller (such as console 201; see FIG. 2) is able to open and close ports 205 by actuating inlet solenoids 305 into an open or closed position. In the depicted embodiment, inlet solenoids 305 comprise a high-side inlet solenoid 305a and a low-side inlet solenoid 305b, each of the inlet solenoids 305 effectively opening or closing fluid communication at their associated port 205. Main manifold 303 is additionally in fluid communication with a cart compressor 307 that can be used to initiate flow of refrigerant through the manifolds and also refrigeration circuit 300 when hoses 105 are connected in fluid communication between the service cart circuit and refrigeration circuit 300. In the depicted embodiment, a vehicle compressor 327 associated with refrigeration 300 is additionally depicted. Vehicle compressor 327 is utilized by the vehicle during normal operation of the refrigeration circuit 300 to generate cool air for the passenger cabin of the vehicle, but in both normal operation and during service vehicle compressor 327 is additionally able to circulate refrigerant through the circuits and manifolds depicted.

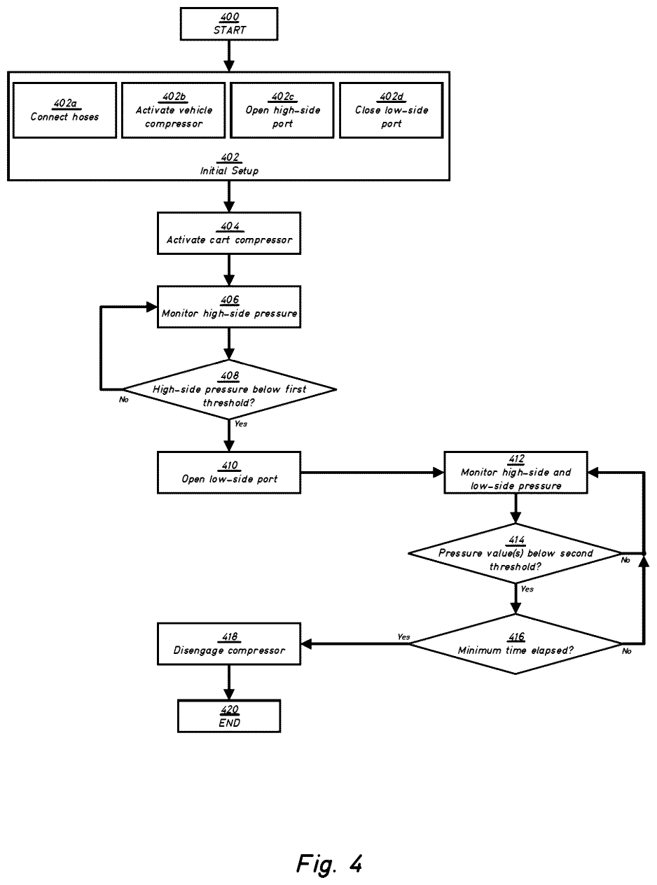

FIG. 4 is a flowchart illustrating a method utilizing a service cart (such as service cart 103; see FIG. 1, FIG. 2) in fluid communication with a refrigeration circuit of a vehicle (such as refrigeration circuit 300; see FIG. 3) for a rapid recovery process according to the teachings disclosed herein.

The method starts at step 400 and proceeds to an initial setup at step 402. The initial setup is comprised of a number of sub-steps that may be accomplished in any order, concurrently, or in any combination of partially concurrent orders without deviating from the teachings disclosed herein. In the depicted embodiment, it is preferred that step 402a is completed first, where hoses (such as hoses 105; see FIG. 1, FIG. 3) are connected between the high-side port and low-side port of the service cart and corresponding ports of the vehicle. Connecting hoses at step 402a advantageously prevents any accidental spillage or leakage of refrigerant during the recovery. In order to maximize the efficiency of the rapid recovery, the compressor associated with the vehicle refrigerant circuit (such as vehicle compressor 327; see FIG. 3) should be activated, which is accomplished in step 402b. Typically, this activation is accomplished by placing the air conditioning circuit of the vehicle in an active state within the cabin of the vehicle. Additionally in the initial setup step 402, the high-side port of the service cart should be placed in an open condition and the low-side port of the service cart should be placed in a closed condition. At step 402c it is ensured that the high-side port of the service cart is open: including opening the high-side port if it is closed or partially open, and leaving the high-side port open if it is already in an open state. At step 402d it is ensured that the low-side port is closed: including closing the low-side port if it is open or partially open, and leaving the low-side port closed if it is already in an open state.

After all the sub-steps of step 402 are complete, the system has been placed into an appropriate initial condition to begin the recover process, and the compressor of the service cart (such as compressor 307; see FIG. 3) is activated. At this point, both the vehicle-side compressor and the cart-side compressor are working in tandem to maximally transfer refrigerant from the refrigeration circuit of the vehicle into the storage tank (such as storage tank 207; see FIG. 2) of the service cart. This maximal transfer is accomplished because only the high-side conduit is in a state of active fluid communication while the low-side port is closed, and additional pressure to increase flow is achieved by simultaneous pumping of the vehicle-side compressor and the cart-side compressor concurrently.

This tandem utilization of both compressors results in a much faster transfer of refrigerant than relying upon the cart-side compressor alone. However, the finite amount of refrigerant available means that as refrigerant is captured into the storage tank of the service cart, the pressure experienced at the high-side port will necessarily decrease as the remaining refrigerant decreases in volume and can no longer sustain the increased pressure level. Modern vehicles are typically equipped with a sensor and shut-off failsafe that deactivates the vehicle-side compressor when a loss of pressure is detected in the refrigerant circuit. This failsafe is intended to prevent continued flushing of refrigerant into the atmosphere in response to a leak in the circuit, but in this case may advantageously be utilized to provide an indication that the bulk of the refrigerant in the circuit has been recovered from the vehicle circuit and into the storage tank. In order to capitalize on this failsafe mechanism properly, the method at step 406 monitors the pressure of the high-side port. If the high-side pressure remains above a first threshold at step 408, the method returns to step 406 to acquire additional pressure data. Once the pressure at the high-side port falls below the first threshold, the method instead proceeds to step 410.

The value of the first threshold will depend upon the make and model of the vehicle, and its corresponding shutoff conditions for the refrigeration circuit. For this reason, the first threshold is a selectable threshold, and may be input by a user to a controller using a console (such as console 201; see FIG. 2). By way of example, and not limitation, the first threshold may be selectable in a range of 30 to 400 pounds per square inch (PSI), as a typical pressure experienced when both the vehicle-side and cart-side compressors are operating may be in the range of 150 to 350 PSI, while cart-side only compressor recovery may exert 30 to 50 PSI. In some embodiments, the first threshold may be set to detect when the pressure falls to within a range of 30 to 50 PSI without deviating from the teachings disclosed herein. In such embodiments, the first threshold has been selected to respond to a detection that only a pressure consistent with the cart-side compressor being in activation is observed.

Once the pressure drops below the first threshold, it is understood that the vehicle-side compressor is no longer active, and the remaining recovery process should be accomplished utilizing only the cart-side components. At step 410, the low-side port is opened, and the recovery process continues utilizing just the cart-side compressor. Note that in the depicted embodiment, the vehicle-side compressor is automatically shut off without any intervention from the service cart.

The end of the second phase of recovery is determined when the recovery has driven the refrigeration circuit down to a vacuum or near-vacuum conditions (depending on the specification of the vehicle based upon make and model). For this reason, the method continues to step 412, where the high-side and low-side pressures are monitored. At step 414, the pressure data is observed to determine if one or both of the high-side pressure data or the low-side pressure data indicates that pressure has fallen below a second threshold. If not, the method returns to step 412 to generate additional pressure data. If some embodiments, both the high-side and low-side pressure being blow the second threshold may be suitable to advance past step 414, but other embodiments may require both values to be below the second threshold without deviating from the teachings disclosed herein. Once the pressure data has dropped below the second threshold, the method proceeds to step 416, where a timer is initiated upon the first instance of step 416. If a minimum amount of time has not elapsed since the timer has been initiated, the method returns to step 412. Note that the timer is not reset by either step 412 or 414, nor by additional reentry into step 416. In this manner, the timer provides a continuous window time has elapsed since the initial point at which the pressure fell below the second threshold. Once the minimum window of time has elapsed, it is understood that that circuit has been reduced to the requisite vacuum or near-vacuum conditions, and the method proceeds to step 418, where the cart-side compressor is disengaged and the timer is reset. The method then ends at step 420.

In the depicted embodiment, the second threshold value is selectable according to the specification of the cart-side compressor. By way of example, and not limitation, the second threshold may be a value below 1 PSI, but other embodiments may comprise other values without deviating from the teachings disclosed herein. In some embodiments, the second threshold may be selected by a user via a console (such as console 201; see FIG. 2) in order to accommodate manufacturer specifications for different makes and models of vehicle, or to accommodate a change in operating conditions of the cart-side compressor.

In the teachings herein, the window of time may be selected by a user and input using a console (such as console 201; see FIG. 2) in order to accommodate a variety of specifications according to the make and model of the vehicle, or the operating conditions of the service cart. In some embodiments, the window of time may be set to 0 milliseconds, effectively eliminating step 416 from the method without deviating from the teachings disclosed herein. Some embodiments of the method may not comprise a step 416 at all without deviating from the teachings disclosed herein. In other embodiments, the window of time may be a value less than 10 seconds without deviating from the teachings disclosed herein.

This method advantageously improves over the operational time of a conventional, single-compressor recovery. It has been shown experimentally that utilization of this method can result in an improvement in recovery time from an conventional time on the order of 15 minutes to an improved time of 6 minutes or less utilizing this rapid recovery method.

In the depicted embodiment, the high-side pressure data and low-side pressure data are generated by transducers in fluid communication with the respective ports (such as high-side transducer 315a and low-side transducer 315b; see FIG. 3). The transducers may be in data communication with a controller that is configured to operate components of a service cart, including a high-side port and low-side port. In some embodiments, the pressure data may be presented to a user via a human-machine interface (such as console 201; see FIG. 2), and the user may provide inputs indicating control via a console (such as console 201; see FIG. 2) without deviating from the teachings disclosed herein.

The preferred embodiment of the disclosed invention utilizes a controller responding to instructions provided by a non-transitory computer readable medium. In the depicted embodiments, the controller may be embodied as single-function processor, but may instead comprise a mobile processing device, a smartphone, a tablet computer, a laptop computer, a wearable computing device, a desktop computer, a personal digital assistant (PDA) device, a handheld processor device, a specialized processor device, a system of processors distributed across a network, a system of processors configured in wired or wireless communication, or any other alternative embodiment known to one of ordinary skill in the art. Instructions for the controller may be provided by a non-transitory computer-readable medium. In the depicted embodiment, the non-transitory computer-readable medium may comprise a programmable memory, but other embodiments may be embodied as a non-transitory computer-readable storage medium or a machine-readable medium for carrying or having computer-executable instructions or data structures stored thereon. Such non-transitory computer-readable storage media or machine-readable medium may be any available media embodied in a hardware or physical form that can be accessed by a general purpose or special purpose computer. By way of example, and not limitation, such non-transitory computer-readable storage media or machine-readable medium may comprise random-access memory (RAM), read-only memory (ROM), electrically erasable programmable read-only memory (EEPROM), optical disc storage, magnetic disk storage, linear magnetic data storage, magnetic storage devices, flash memory, or any other medium which can be used to carry or store desired program code means in the form of computer-executable instructions or data structures. Combinations of the above should also be included within the scope of the non-transitory computer-readable storage media or machine-readable medium.

While exemplary embodiments are described above, it is not intended that these embodiments describe all possible forms of the disclosed apparatus and method. Rather, the words used in the specification are words of description rather than limitation, and it is understood that various changes may be made without departing from the spirit and scope of the disclosure as claimed. The features of various implementing embodiments may be combined to form further embodiments of the disclosed concepts.

What is claimed is:

1. A method of refrigerant recovery from a vehicle using a service cart having a high-side port and a low-side port each in fluid communication with an active refrigeration circuit of the vehicle, the method comprising:
engaging a compressor of the service cart;
engaging the high-side port such that it is open and the low-side port such that it is closed; and
opening the low-side port in response to a high-side pressure data value falling below a first threshold value,
wherein
the high-side pressure data is generated by a high-side transducer in fluid communication with the high-side port, and
the high-side port and the low-side port are controlled by a controller in data communication with the high-side transducer.

2. The method of claim 1, wherein the step of engaging the compressor and engaging the high-side port and the low-side port are performed concurrently.

3. The method of claim 1, further comprising:
disengaging the compressor in response to the high-side pressure data and a low-side pressure data falling below a second threshold value for a window of time,
wherein
the low-side pressure data is generated by a low-side transducer in fluid communication with the low-side port, and
the compressor is controlled by the controller.

4. The method of claim 3, wherein the window of time is 0 seconds.

5. The method of claim 3, wherein the window of time is selectable.

6. The method of claim 3, wherein the second threshold value is selectable.

7. The method of claim 1, wherein the first threshold is selectable.

8. The method of claim 1, wherein the first threshold is 50 psi or less.

9. The method of claim 8, wherein the first threshold is 30 psi or less.

10. The method of claim 8, wherein the high-side pressure data includes a peak value of 100-400 psi.

11. The method of claim 1, wherein the first threshold is equivalent to a pressure that corresponds with an active disengagement of a vehicle compressor of the vehicle refrigeration circuit.

12. A method of refrigerant recovery from a vehicle using a service cart having a high-side port and a low-side port each in fluid communication with an active refrigeration circuit of the vehicle, the method comprising:
engaging the high-side port such that it is open and the low-side port such that it is closed;
engaging a compressor of the service cart; and
opening the low-side port in response to a high-side pressure data value falling below a first threshold value,
wherein
the high-side pressure data is generated by a high-side transducer in fluid communication with the high-side port, and
the high-side port and the low-side port are controlled by a controller in data communication with the high-side transducer.

13. The method of claim 12, wherein the step of engaging the compressor and engaging the high-side port and the low-side port are performed concurrently.

14. The method of claim 12, further comprising:
disengaging the compressor in response to the high-side pressure data and a low-side pressure data falling below a second threshold value for a window of time,
wherein
the low-side pressure data is generated by a low-side transducer in fluid communication with the low-side port, and
the compressor is controlled by the controller.

15. A non-transitory processor-readable medium having instructions stored thereon that, when read by a processor in data communication with a service cart having a high-side port and a low-side port in fluid communication with a refrigerant circuit of a vehicle with an engaged refrigerant circuit, cause the processor to perform the steps of:
engaging a compressor of the service cart;
opening the high-side port;
generating high-side pressure data indicating a fluid pressure exhibited at the first high-side port; and
opening the first low-side port in response to the high-side pressure data value falling below a first threshold value,
wherein
the high-side pressure data is generated using a high-side transducer of the service cart, the high-side transducer in fluid communication with the high-side port.
